(19) United States
(12) Patent Application Publication
(10) Pub. No.: US 2005/0266701 A1
(43) Pub. Date: Dec. 1, 2005

(54) Semiconductor device, method for manufacturing the same, circuit board, and electronic equipment

(76) Inventor: Akiyoshi Aoyagi, Sagamihara-shi (JP)

Correspondence Address: HARNESS, DICKEY & PIERCE, P.L.C., P.O. BOX 828, BLOOMFIELD HILLS, MI, 48303, US

(21) Appl. No.: 11/137,703

(22) Filed: May 25, 2005

(30) Foreign Application Priority Data
May 26, 2004 (JP) 2004-156270

(51) Int. Cl. H01R 12/00

(52) U.S. Cl. 439/66

(57) ABSTRACT

A semiconductor chip includes a first package, a second package, a contact part for electrically coupling a first wiring pattern and a second wiring pattern, a reinforcing part, and an adhesive part. The first package has a larger coefficient of thermal expansion than the second package. The second package is placed so that a second interposer overlaps a first semiconductor chip and a first interposer. The contact part has a first end coupled to the first wiring pattern and a second end coupled to the second wiring pattern. The contact part is provided between the first interposer the second interposer. The reinforcing part exposes part of the contact part and covers the periphery of the first end of the contact part. The adhesive part is provided between the first interposer and the second interposer so as not to come in contact with the contact part, and joins the first package and the second package.

### RELATED APPLICATIONS

This application claims priority to Japanese Patent Application No. 2004-156270 filed May 26, 2004 which is hereby expressly incorporated by reference herein in its entirety.

### BACKGROUND

1. Technical Field

The present invention relates to a semiconductor device, a method for manufacturing the same, a circuit board, and electronic equipment.

2. Related Art

Stacked semiconductor devices have been developed. Semiconductor chips in the devices are mounted three dimensionally, reducing two-dimensional space required. Furthermore, the device can be formed by combining existing semiconductor chips and thus do not require new design for integrated circuits. However, if each semiconductor chip is supported by an interposer, the bonding strength between upper and lower interposers affects reliability. If any moisture remains between upper and lower interposers, it can turn into water vapor through high-temperature reflow processing, resulting in separation of the upper and lower interposers.

The present invention aims to improve the bonding strength between upper and lower interposers when each of a plurality of semiconductor chips is supported by an interposer.

### SUMMARY

A semiconductor device according to one aspect of the present invention includes:
a first package, the first package including:
   a first interposer provided with a first wiring pattern, and
   a first semiconductor chip mounted on the first interposer and electrically coupled to the first wiring pattern;
a second package, the second package including:
   a second interposer provided with a second wiring pattern, and
   a second semiconductor chip mounted on the second interposer and electrically coupled to the second wiring pattern;
a contact part electrically coupling the first wiring pattern and the second wiring pattern;
a reinforcing part; and
an adhesive part;
the first package having a larger coefficient of thermal expansion than the second package;
the second package being placed so that the second interposer overlaps the first semiconductor chip and the first interposer;
the contact part having a first end coupled to the first wiring pattern and a second end coupled to the second wiring pattern, and the contact part being provided between the first interposer the second interposer;
the reinforcing part exposing part of the contact part and covering a periphery of the first end of the contact part; and
the adhesive part being provided between the first interposer and the second interposer so as not to come in contact with the contact part, and joining the first package and the second package.

Since the first and second packages are joined with the adhesive part, it is possible to increase bonding strength between the first and second interposers. Therefore, peeling off of the first and second interposers is prevented through the manufacturing process. In addition, since the adhesive part is provided between the first and second interposers so as not to come in contact with the contact part, it is possible to provide a large space for releasing water vapor etc. Therefore, peeling off of the first and second packages due to remaining water vapor is prevented, which further increases bonding strength between the first and second interposers.

In the semiconductor device, the adhesive part may join the first semiconductor chip and the second interposer.

In the semiconductor device, the adhesive part may be provided inside the first semiconductor chip. This way the adhesive part is surely provided in an area except for the contact part.

In the semiconductor device, the adhesive part may join the first interposer and the second interposer.

In the semiconductor device, the second interposer may have a rectangular outer shape, and the adhesive part may be provided to an end of the second interposer.

In the semiconductor device, the adhesive part may be provided to at least one corner of the second interposer.

In the semiconductor device, the adhesive part may be provided to an area except for corners of the second interposer.

In the semiconductor device, the adhesive part may be provided on the inner side of the contact part.

In the semiconductor device, the second package may further include a sealing part provided to the second interposer so as to seal the second semiconductor chip, and the first interposer may have a larger coefficient of thermal expansion than the sealing part.

The semiconductor device may further includes a plurality of second packages placed with a gap therebetween so as not to overlap each other.

On a circuit board according to another aspect of the invention, the semiconductor device is mounted.

Electronic equipment according to yet another aspect of the invention includes the semiconductor device.

A method for manufacturing a semiconductor device according to a further aspect of the invention includes:
(a) providing a first package by mounting a first semiconductor chip on a first interposer provided with a first wiring pattern so that the first semiconductor chip is electrically coupled to the first wiring pattern;
(b) providing a second package by mounting a second semiconductor chip on a second interposer provided with a second wiring pattern so that the second semiconductor chip is electrically coupled to the second wiring pattern;
(c) placing the second package so that the second interposer overlaps the first semiconductor chip and the first interposer; and
(d) between the first interposer and the second interposer, making a contact part for electrically coupling the first wiring pattern and the second wiring pattern from a first material, making a reinforcing part from a second material, and making an adhesive part for joining the first package and the second package from an adhesive material;
the first package having a larger coefficient of thermal expansion than the second package;
the contact part including a first end coupled to the first wiring pattern and a second end coupled to the second wiring pattern; and
in the step (d) the reinforcing part is provided to expose part of the contact part and cover a periphery of the first end of the contact part, and the adhesive part is provided to join the first package and the second package and not to come in contact with the contact part.

Since the first and second packages are joined with the adhesive part, it is possible to increase bonding strength between the first and second interposers. In addition, since the adhesive part is provided between the first and second interposers so as not to come in contact with the contact part, it is possible to provide a large space for releasing water vapor etc. Therefore, peeling off of the first and second packages due to remaining water vapor is prevented, which further increases bonding strength between the first and second interposers.

In the method for manufacturing a semiconductor device, the adhesive material may be provided to at least one of the first package and the second package before the step (c).

In the method of manufacturing a semiconductor device, a plurality of second packages may be provided in the step (b), and the plurality of second packages may be placed with a gap therebetween so as not to overlap each other in the step (c).

In the method for manufacturing a semiconductor device, the adhesive material may be injected from the gap between the plurality of second packages before the step (d). This way the adhesive material progresses in the directions of the plurality of second packages from the gap. In other words, since the adhesive material progresses in plural directions, the injection is completed in a short period of time.

### BRIEF DESCRIPTION OF THE DRAWINGS

FIG. 1 is a plan view illustrating a semiconductor device according to one embodiment of the present invention.

FIG. 2 is a sectional view of the semiconductor device shown in FIG. 1 along the line II-II.

FIG. 3 is a partial enlarged view of FIG. 2.

FIG. 4 is a diagram illustrating a method for manufacturing a semiconductor device according to a first embodiment of the invention.

FIG. 5 is a diagram illustrating the method for manufacturing a semiconductor device according to the first embodiment of the invention.

FIG. 6 is a diagram illustrating the method for manufacturing a semiconductor device according to the first embodiment of the invention.

FIG. 7 is a diagram illustrating the method for manufacturing a semiconductor device according to the first embodiment of the invention.

FIG. 8 is a diagram illustrating the method for manufacturing a semiconductor device according to the first embodiment of the invention.

FIG. 9 is a diagram illustrating the method for manufacturing a semiconductor device according to the first embodiment of the invention.

FIG. 10 is a diagram illustrating the method for manufacturing a semiconductor device according to the first embodiment of the invention.

FIG. 11 is a plan view illustrating a semiconductor device according to a second embodiment of the invention.

FIG. 12 is a plan view illustrating a semiconductor device according to a modification of the second embodiment of the invention.

FIG. 13 is a plan view illustrating a semiconductor device according to a modification of the second embodiment of the invention.

FIG. 14 is a plan view illustrating a semiconductor device according to a modification of the second embodiment of the invention.

FIG. 15 is a plan view illustrating a semiconductor device according to a third embodiment of the invention.

FIG. 16 is a sectional view of the semiconductor device shown in FIG. 15 along the line XVI-XVI.

FIG. 17 is a diagram illustrating a method for manufacturing a semiconductor device according to the third embodiment of the invention.

FIG. 18 is a diagram illustrating the method for manufacturing a semiconductor device according to the third embodiment of the invention.

FIG. 19 is a diagram illustrating the method for manufacturing a semiconductor device according to the third embodiment of the invention.

FIG. 20 is a diagram illustrating the method for manufacturing a semiconductor device according to the third embodiment of the invention.

FIG. 21 is a diagram illustrating the method for manufacturing a semiconductor device according to the third embodiment of the invention.

FIG. 22 shows a circuit board on which a semiconductor device according to any of the embodiments of the invention is mounted.

FIG. 23 shows electronic equipment including a semiconductor device according to any of the embodiments of the invention.

FIG. 24 shows electronic equipment including a semiconductor device according to any of the embodiments of the invention.

### DETAILED DESCRIPTION

Embodiments of the present invention will be described with reference to the accompanying drawings.

### First Embodiment

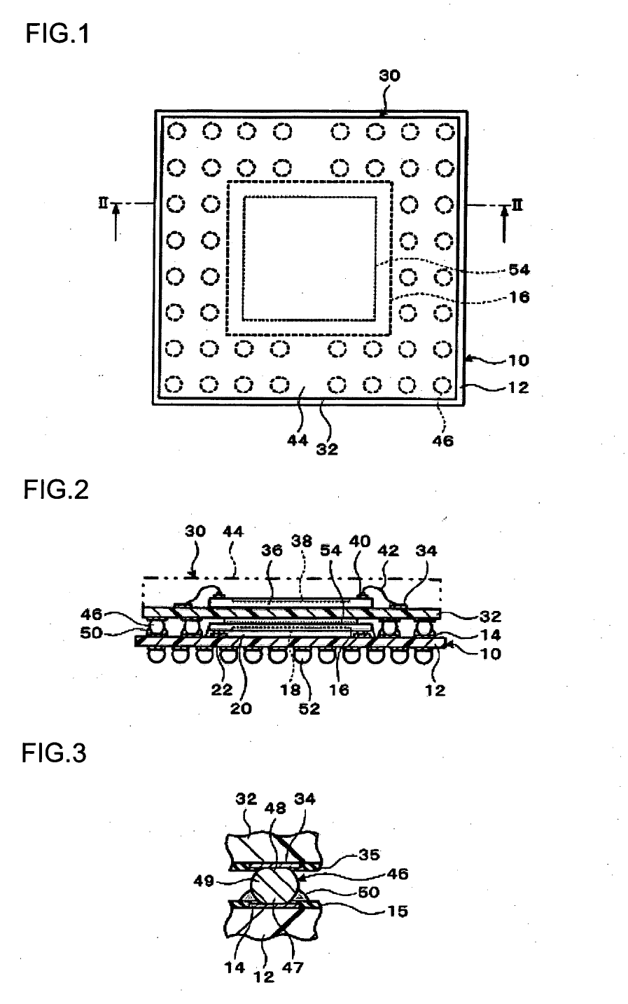

FIG. 1 is a plan view illustrating a semiconductor device according to a first embodiment of the invention. FIG. 2 is a sectional view of the semiconductor device shown in FIG. 1 along the line II-II. FIG. 3 is a partial enlarged view of FIG. 2.

The semiconductor device includes a first package 10. The first package 10 includes a first interposer 12. The first interposer 12 is a substrate, and may be a plate. The first interposer 12 may have a rectangular outer shape. The first interposer 12 may be made of a resin such as polyimide resin, or of a mixed material of organic (e.g. resin) and inorganic materials. Alternatively, the first interposer 12 may be a metal or ceramic substrate. The first interposer 12 is provided with a first wiring pattern 14. The first wiring pattern 14 may include a wiring for electrically coupling a plurality of points, and a land electrically coupled to another part. The first wiring pattern 14 may be covered by an insulating layer 15, except for a certain part on the pattern (e.g. central part of the land). The first wiring pattern 14 is provided on at least one side of the first interposer 12. The first wiring pattern 14 may be provided on the both sides of the first interposer 12 so that they are electrically coupled via a through hole (not shown). The first interposer 12 may be a multilayer or build-up substrate.

The first package 10 includes a first semiconductor chip 16. The first semiconductor chip 16 is provided with an integrated circuit 18. The first semiconductor chip 16 is mounted on the first interposer 12. The first semiconductor chip 16 is joined to the first interposer 12 with an adhesive 20. The adhesive 20 may be a resin. The adhesive 20 may be energy setting (e.g., thermosetting, ultraviolet curing). The adhesive 20 may be an electric insulation.

The first semiconductor chip 16 is electrically coupled to the first wiring pattern 14. As shown in FIG. 2, the first semiconductor chip 16 may be bonded face-down to the first interposer 12. In this case, a bump 22 that serves as an electrode of the first semiconductor chip 16 may be placed face to face with the first wiring pattern 14, making the two be electrically coupled to each other. If the adhesive 20 is an anisotropic conductive material (e.g., anisotropic conductive film or paste), conductive particles provide electrical coupling. If the adhesive 20 is an insulating adhesive, its contraction force may be used for bonding the bump 22 and the first wiring pattern 14 with pressure. Alternatively, the bump 22 and the first wiring pattern 14 may be joined with a metal junction. As a modification, the first semiconductor chip 16 may be bonded face-up to the first interposer 12 while using a wire for electrical coupling.

The semiconductor device includes a second package 30. The second package 30 includes a second interposer 32. The second interposer 32 may have a rectangular outer shape. The details of the second interposer 32 are the same as the above description of the first interposer 12. Furthermore, the second interposer 32 may be made of the same material, to the same thickness, with the same coefficient of thermal expansion as those of the first interposer 12. Alternatively, the second interposer 32 may be made of a different material and to a different thickness from those of the first interposer 12. The coefficient of thermal expansion of the second interposer 32 may be smaller than that of the first interposer 12. Note that the coefficient of thermal expansion is the percentage of contraction when cooled down as well as the percentage of expansion when heated. The second interposer 32 is provided with a second wiring pattern 34. The details of the second wiring pattern 34 are the same as the above description of the first wiring pattern 14. The second wiring pattern 34 may be covered by an insulating layer 35, except for a certain part on the pattern (e.g. central part of the land).

The second package 30 includes a second semiconductor chip 36. The second semiconductor chip 36 is provided with an integrated circuit 38. The second semiconductor chip 36 is mounted on the second interposer 32 and electrically coupled to the second wiring pattern 34. The second semiconductor chip 36 may be joined to the second interposer 32 with an adhesive (not shown). As shown in FIG. 2, the second semiconductor chip 36 may be bonded face-up to the second interposer 32. In this case, a pad 40 of the second semiconductor chip 36 and the second wiring pattern 34 may be bonded to a wire 42. As a modification, the second semiconductor chip 36 may be bonded face-down to the second interposer 32. In this case, the same as the description of the first semiconductor chip 16 can be applied to provide electrical coupling.

The second package 30 includes a sealing part 44. The sealing part 44 seals the second semiconductor chip 36 and seals an electrical coupling part (e.g. the wire 42). The sealing part 44 is provided to the second interposer 32. The sealing part 44 may be formed to overlap a plurality of contact parts that will be described later. The sealing part 44 may be made of a resin (e.g. molded resin). The coefficient of thermal expansion of the sealing part 44 is smaller than that of the first interposer 12. The coefficient of thermal expansion of the sealing part 44 is also smaller than that of the second interposer 32. In order to have a small coefficient of thermal expansion, the sealing part 44 may contain silica. Even if the coefficients of thermal expansion of the first interposer 12 and the second interposer 32 are equal as single substances, providing the sealing part 44 makes the coefficient of thermal expansion of the second interposer 32 (or second package 30) smaller than that of the first interposer 12 (or first package 10).

The second package 30 is provided to overlap the first package 10. More specifically, the second interposer 32 overlaps the first semiconductor chip 16 and the first interposer 12. The second interposer 32 overlaps the whole area of the first semiconductor chip 16. One second package 30 may be disposed on the first package 10.

The second package 30 (second interposer 32) is stacked on one side of the first package 10 (first interposer 12) on which the first semiconductor chip 16 is mounted. Alternatively, one side of the second package 30 (second interposer 32) on which the second semiconductor chip 36 is mounted may be placed on the other side of the first package 10 (first interposer 12) opposite to the one side on which the first semiconductor chip 16 is mounted.

Provided between the first package 10 (first interposer 12) and the second package 30 (second interposer 32) are a plurality of contact parts 46. Each contact part 46 electrically couples the first wiring pattern 14 and the second wiring pattern 34. For example, part of the first wiring pattern 14 (e.g. land) and part of the second wiring pattern 34 (e.g. land) may be placed face to face with each other with the contact part 46 therebetween. Of the contact part 46, a first end 47 is coupled to the first wiring pattern 14 and a second end 48 is coupled to the second wiring pattern 34. The contact part 46 may be made of either soft solder or hard solder. Here, solder that does not contain lead (hereinafter referred to as “lead-free solder”) may be used as a soft solder material. As the lead-free solder, an alloy of tin-silver (Sn—Ag), tin-bismuth (Sn—Bi), tin-zinc (Sn—Zn), or tin-copper (Sn—Cu) may be used. Alternatively, at least one of silver, bismuth, zinc, and copper may be added to these alloys. The contact part 46 has an intermediate part 49 whose cross section is the largest. The first end 47 and the second end 48 of the contact part 46 has a smaller cross section than that of the intermediate part 49 of the contact part 46. The contact part 46 may be part of a substantial sphere.

Provided between the first interposer 12 and the second interposer 32 is a reinforcing part 50. The reinforcing part 50 exposes part of each contact part 46 and covers the first end 47 of each contact part 46. The exposed part of the contact part 46 from the reinforcing part 50 may be the second end 48 of the contact part 46 alone, or a portion from the intermediate part 49 to the second end 48 of the contact part 46 (more than half on one side). The reinforcing part 50 is provided not to come in contact with the second interposer 32. The reinforcing part 50 may cover the entire circumference of the first end 47. More specifically, the reinforcing part 50 may cover the entire circumference edge of the contact interface between the contact part 46 and the first wiring pattern 14. The reinforcing part 50 may spread on the insulating layer 15 provided on an end of the land included in the first wiring pattern 14.

The reinforcing part 50 may be provided to keep adjacent contact parts 46 from coming in contact with each other. The reinforcing part 50 may be provided in an area except for the one between adjacent contact parts 46. The first interposer 12 may be exposed from an area between adjacent contact parts 46. Alternatively, the reinforcing part 50 may be provided to at once cover a plurality of first ends (each corresponding to the first end 47) of the plurality of contact parts 46.

In the present embodiment, the reinforcing part 50 includes a resin (e.g. thermosetting resin). The reinforcing part 50 may be an adhesive. This adhesive joins and reinforces the periphery of the contact part 46. The reinforcing part 50 may also include a flux. This influx enhances the wettability of the solder material of the contact part 46, and thereby providing desirable electrical coupling between the contact part 46 and the first wiring pattern 14. The reinforcing part 50 may also include a solder material. The solder material may be either the same as or different from the material of the contact part 46. This material ensures electrical coupling between the contact part 46 and the first wiring pattern 14. Alternatively, an underfill flux or underfill paste may be used as the reinforcing part 50. The reinforcing part 50 may be a mixture of a resin, flux, and solder material. Alternatively, the reinforcing part 50 may be a mixture of a resin and flux, or a resin and solder material. Here, if the reinforcing part 50 includes a solder material that is conductive, a short-circuit does not occur between adjacent contact parts 46 since the solder material remains in the first wiring pattern 14.

According to the present embodiment, the reinforcing part 50 covers the first end 47, which is coupled to the first wiring pattern 14, of the contact part 46. The first package 10 provided with the first wiring pattern 14 has a larger coefficient of thermal expansion than the second package 30, and thereby the percentage of expansion when heated and the percentage of contraction when cooled down are larger. As a result, although the first end 47 coupled to the first wiring pattern 14 receives a larger stress in the contact part 46, the contact part 46 is effectively reinforced by the reinforcing part 50 in the present embodiment. Furthermore, since the reinforcing part 50 exposes part of the contact part 46, a space for releasing water vapor is provided between the first package 10 and the second package 30. Therefore, peeling off of the first package 10 and the second package 30 due to remaining water vapor is prevented. Accordingly, bonding strength between the first interposer 12 and the second interposer 32 is increased. Since the contact part 46 is not sealed by the reinforcing part 50, no sealed space is damaged by an inflated volume when re-melted (e.g. when reflowing external terminals 52), which further increases bonding strength between the first interposer 12 and the second interposer 32.

The semiconductor device may include a plurality of external terminals 52 (e.g. solder balls). Each of the external terminals 52 is provided on one side of the first interposer 12 opposite to the other side on which the first semiconductor chip 16 is mounted. The external terminal 52 may be provided on a land included in the first wiring pattern 14. The external terminal 52 may be made of either soft solder or hard solder. Here, the above-described lead-free solder may be used as a soft solder material.

The first package 10 and the second package 30 are joined with an adhesive part 54. The adhesive part 54 may be a resin (e.g. thermosetting resin). The adhesive part 54 is provided between the first interposer 12 and the second interposer 32 so as not to come in contact with the contact part 46. The adhesive part 54 may be provided so as not to come in contact with the reinforcing part 50.

In the present embodiment, the adhesive part 54 joins the first semiconductor chip 16 and the second interposer 32. The adhesive part 54 may be provided to a gap between the first semiconductor chip 16 and the second interposer 32. As shown in FIG. 1, the adhesive part 54 may be provided inside the first semiconductor chip 16 (e.g. central part of the chip). This way the adhesive part 54 is surely provided in an area except for the contact part 46. Also, since the gap between the first semiconductor chip 16 and the second interposer 32 is thin, it is possible to join them in a limited planar area.

Alternatively, if the first semiconductor chip 16 is bonded face-down, the adhesive part 54 may cover the whole area of the first semiconductor chip 16. The adhesive part 54 may also run out of the first semiconductor chip 16. Meanwhile, if the first semiconductor chip 16 is bonded face-up, the adhesive part 54 may be provided in an area except for an electrical coupling part (e.g. pad and wire) from the first semiconductor chip 16, or may cover them.

According to the present embodiment, since the first package 10 and the second package 30 are joined with the adhesive part 54, it is possible to increase bonding strength between the first interposer 12 and the second interposer 32. Therefore, peeling off of the first interposer 12 and the second interposer 32 is prevented through the manufacturing process. Furthermore, since the adhesive part 54 is provided between the first interposer 12 and the second interposer 32 so as not to come in contact with the contact part 46, it is possible to provide a large space for releasing water vapor etc. Therefore, peeling off of the first package 10 and the second package 30 due to remaining water vapor is prevented, which further increases bonding strength between the first interposer 12 and the second interposer 32.

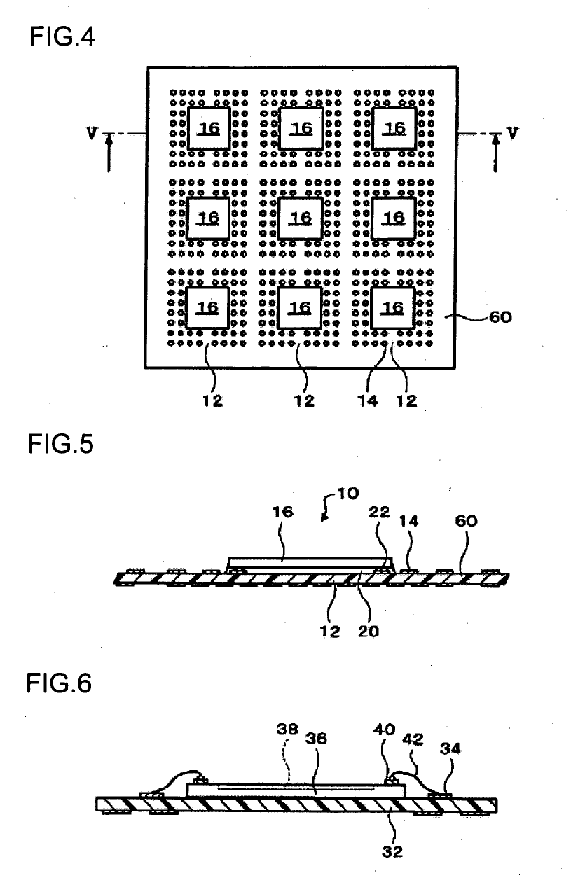

FIG. 4 is a diagram showing part of a method for manufacturing a semiconductor device according to one embodiment of the invention. More specifically, FIG. 4 illustrates the assembly of the first package. FIG. 5 is a partial enlarged view along the line V-V in FIG. 4. In the present embodiment, a first interposer 60 is used. The first interposer 60 is cut and divided into a plurality of first interposers each corresponding to the first interposer 12 shown in FIG. 1 in a later stage. In other words, the first interposer 60 includes areas to be the plurality of first interposers 12. The first interposer 60 is provided with a plurality of first wiring patterns each corresponding to the first wiring pattern 14. As a modification, the first interposer 12 to be included in individual first packages may be used in the assembly.

The first semiconductor chip 16 is mounted on the first interposer 12. In the present embodiment, the first semiconductor chip 16 is mounted on individual areas to be the plurality of first interposers 12 included in the first interposer 60. The first semiconductor chip 16 is joined to the first interposer 12 with the adhesive 20. Also, the first semiconductor chip 16 is electrically coupled to the first wiring pattern 14. In the present embodiment, each of the plurality of first wiring patterns 14 of the first interposer 60 is electrically coupled to the first semiconductor chip 16. The assembling of the first package 10 includes any processing based on the above description of the first package 10. With each first package 10, a characteristic test of the first semiconductor chip 16 is conducted to see whether it is defective or not. In a later stage, the second package 30 is not stacked on any first package 10 deemed as defective here.

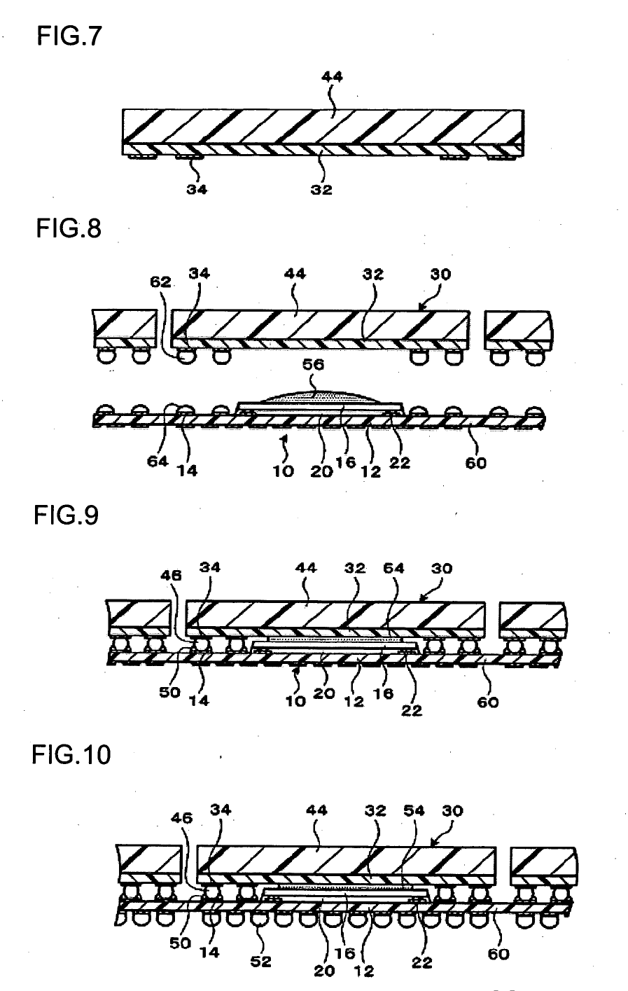

FIGS. 6 and 7 are diagrams showing part of the method for manufacturing a semiconductor device according to the embodiment of the invention. More specifically, FIGS. 6 and 7 illustrate the assembly of the second package. In the present embodiment, as shown in FIG. 6, the second semiconductor chip 36 is mounted on the second interposer 32 provided with the second wiring pattern 34. The second semiconductor chip 36 may be joined to the second interposer 32 with an adhesive (not shown). Also, the second semiconductor chip 36 is electrically coupled to the second wiring pattern 34. The detailed process may be based on the above description of the second package 30. As a modification, a second interposer including areas to be a plurality of second interposers each corresponding to the second interposer 32 may be used. The details of this second interposer are the same as the above description of the first interposer 60.

As shown in FIG. 7, the sealing part 44 is provided to the second interposer 32 so as to seal the second semiconductor chip 36. The sealing part 44 may be formed by transfer molding. The detailed process may be based on the above description of the second package 30. With each second package 30, a characteristic test of the second semiconductor chip 36 is conducted to see whether it is defective or not. The characteristic test may be conducted after providing the sealing part 44, or may be conducted before that. In the latter case, the sealing part 44 may not be provided to any second semiconductor chip 36 deemed as defective.

FIGS. 8 to 10 are diagrams showing the method for manufacturing a semiconductor device according to the embodiment of the invention. According to the present embodiment, the second package 30 is disposed above the first package 10. The second interposer 32 is stacked on one side of the first interposer 12 on which the first semiconductor chip 16 is mounted. The second package 30 is placed so that the second interposer 32 overlaps the first semiconductor chip 16 and the first interposer 12. The detailed process may be based on the above description of the first package 10 and the second package 30.

Before stacking the first package 10 (first interposer 12) and the second package 30 (second interposer 32), a first material 62 for forming the contact part 46 and a second material 64 for forming the reinforcing part 50 are provided between the first interposer 12 and the second interposer 32, for example, at least either of the first interposer 12 or the second interposer 32. The first material 62 is provided to the second interposer 32 side, while the second material 64 is provided to the first interposer 12 side. The first material 62 may be ball-shaped (solid). The first material 62 may be soft solder or hard solder. The above-described lead-free solder may be used as a soft solder material. The first material 62 may be a solder ball. The second material 64 may be a paste. The second material 64 may be a resin paste, and may further include at least either a flux or solder. Any details may be based on the above description of the reinforcing part 50. The second material 64 may be placed face to face with the first material 62. Here, part of the second material 64 may be united with the first material 62, forming the contact part 46.

The first material 62 may be provided to the second interposer 32. More specifically, the first material 62 may be provided to the second wiring pattern 34. The first material 62 may be mounted on each of a plurality of lands included in the second wiring pattern 34, for example. The second material 64 may be provided to the first interposer 12 so as to be placed face to face with the first material 62. The second material 64 may be provided to each of a plurality of lands included in the first wiring pattern 14, or to an area including more than one land, for example. Here, printing (e.g. screen printing), transferring with a pin, application with a dispenser, droplet discharge (e.g. ink jetting), and other methods are applicable for providing the second material 64.

As a modification, the second material 64 may be adhered to the first material 62 in advance, and they may be provided to either of the first interposer 12 or the second interposer 32 (e.g. first interposer 12).

An adhesive material 56 for forming the adhesive part 54 is provided between the first package 10 and the second package 30. According to the present embodiment, the adhesive material 56 is provided to at least either of the first package 10 or the second package 30 before stacking the first package 10 (first interposer 12) and the second package 30 (second interposer 32). The adhesive material 56 may be either a paste or sheet. In either case, applying energy (heat, for example) develops its adhesive force. For example, the adhesive material 56 in paste form may be applied with a dispenser. In the present embodiment, the adhesive material 56 is provided between the first semiconductor chip 16 and the second interposer 32. The adhesive material 56 may be provided inside the first semiconductor chip 16 (e.g. central part of the chip).

Here, the first interposer 60 including areas to be the plurality of first interposers 12 may be used, and the second package 30 may be stacked in each area to be the first interposer 12. Note that the second package 30 is not stacked on any first package 10 deemed as defective. This way it is possible to prevent the second package 30 (second semiconductor chip 36) from being wasted.

Referring to FIG. 9, heat processing (e.g. reflow processing) is conducted to melt the first and second materials 62, 64, making the contact part 46 from the first material 62 and the reinforcing part 50 from the second material 64. The contact part 46 electrically couples the first package 10 and the second package 30. More specifically, the contact part 46 electrically couples the first wiring pattern 14 and the second wiring pattern 34 between the first interposer 12 and the second interposer 32. The reinforcing part 50 is provided so as to cover the first end 47 of the contact part 46. The reinforcing part 50 exposes part of the contact part 46. A gap is provided between the first interposer 12 and the second interposer 32.

The adhesive part 54 is made from the adhesive material 56 by heat processing. The first and second materials 62, 64 and the adhesive material 56 may be heated at the same time. If the adhesive material 56 is a thermosetting resin, it is hardened by heat and thus the adhesive part 54 is formed. The adhesive part 54 joins the first package 10 and the second package 30. As shown in FIG. 9, it is also possible to join the first semiconductor chip 16 and the second interposer 32.

Referring next to FIG. 10, the plurality of external terminals 52 may be provided on one side of the first interposer 12 opposite to the other side on which the first semiconductor chip 16 is mounted. The external terminals 52 are ball-shaped like the first material 62, and may include the same material as the first material 62. If the above-described first interposer 60 is used, it is cut and divided into a plurality of first interposers each corresponding to the first interposer 12.

The present embodiment provides the semiconductor device through the above-describes process. This process includes what is based on the above description about the arrangement of the semiconductor device.

### Second Embodiment

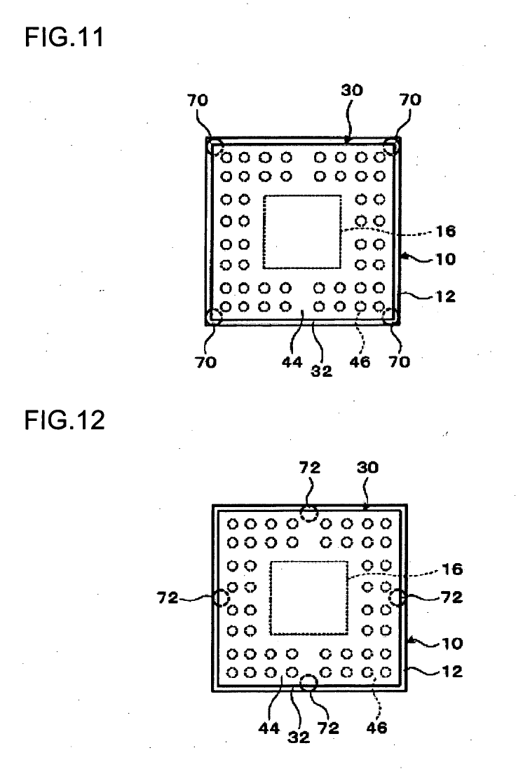

FIG. 11 is a plan view illustrating a semiconductor device according to a second embodiment of the invention. FIGS. 12 through 14 illustrate a modification of the embodiment. In the second embodiment, the arrangement of an adhesive part is different from the first embodiment. Other details of the first embodiment are applicable to the second embodiment.

As shown in FIG. 11, an adhesive part 70 joins the first interposer 12 and the second interposer 32. The adhesive part 70 is provided outside the first semiconductor chip 16. Note that the reinforcing part 70 does not come in contact with the contact part 46. The adhesive part 70 is provided to include a portion where the first interposer 12 and the second interposer 32 overlap each other. The adhesive part 70 is provided to almost the same height to the contact part 46.

The adhesive part 70 may be provided to an edge of the second interposer 32 (or first interposer 12). The adhesive part 70 may be provided on the outer side of the contact part 46. More specifically, if a plurality of contact parts (each corresponding to the contact part 46) are arranged around the first semiconductor chip 16, the adhesive part 70 may be provided on the outer side of the arrangement of the plurality of contact parts 46. If the second interposer 32 is smaller than the first interposer 12, the adhesive part 70 may partially run out of the second interposer 32.

The adhesive part 70 is provided to at least one corner of the second interposer 32. It is also possible to provide a plurality of adhesive parts each corresponding to the adhesive part 70. For example, the plurality of adhesive parts 70 may be provided to the four corners or two diagonal corners of the second interposer.

Referring to FIG. 12, an adhesive part 72 may be provided to an edge of the second interposer 32 except for its corners as a modification. The adhesive part 72 may be provided to at least one of the sides of the second interposer 32. It is also possible to provide a plurality of adhesive parts each corresponding to the adhesive part 72. For example, the plurality of adhesive parts 72 may be provided to the four sides or two opposing sides of the second interposer.

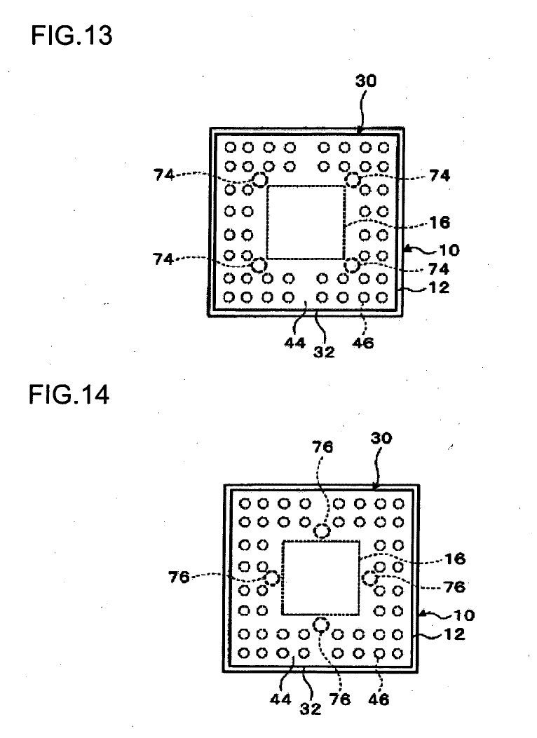

Referring to FIG. 13, an adhesive part 74 may be provided to a part of the second interposer 32 (or first interposer 12) except for its edge as a modification. The adhesive part 74 may be provided on the inner side of the contact part 46. More specifically, if a plurality of contact parts (each corresponding to the contact part 46) are arranged around the first semiconductor chip 16, the adhesive part 74 may be provided on the inner side of the arrangement of the plurality of contact parts 46.

For example, the adhesive part 74 may be provided correspondingly to the corners of the first semiconductor chip 16. A plurality of adhesive parts each corresponding to the adhesive part 74 may be provided correspondingly to the four corners or two diagonal corners of the first semiconductor chip 16.

Referring to FIG. 14, an adhesive part 76 may be provided to an edge of the first semiconductor chip 16 except for its corners as a modification. A plurality of adhesive parts each corresponding to the adhesive part 76 may be provided correspondingly to the four sides or two facing sides of the first semiconductor chip 16.

Note that at least two of the arrangements shown in FIGS. 11 through 14 according to the present embodiment are applicable in combination to arrange adhesive parts. Alternatively, the arrangement of the first embodiment and at least one of the arrangements shown in FIGS. 11 through 14 according to the present embodiment are applicable in combination to arrange adhesive parts.

### Third Embodiment

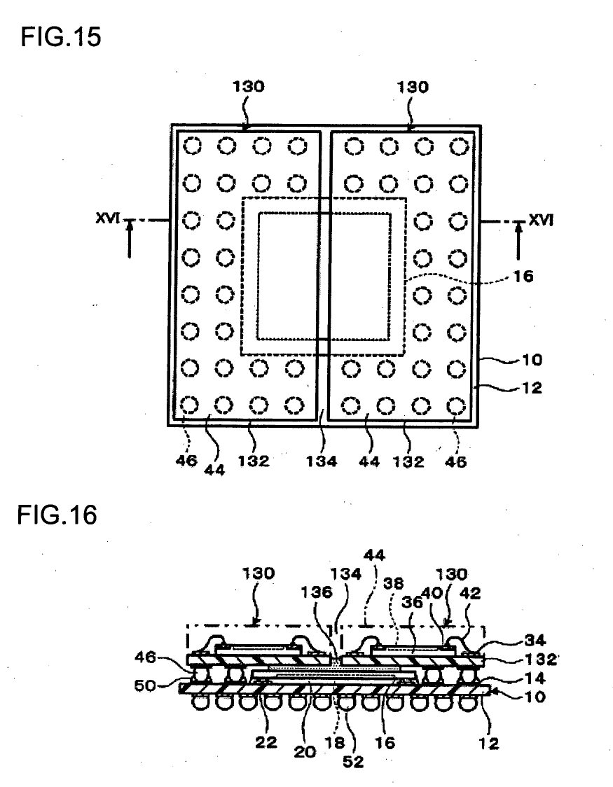

FIG. 15 is a plan view illustrating a semiconductor device according to a third embodiment of the invention. FIG. 16 is a sectional view of the semiconductor device shown in FIG. 15 along the line XVI-XVI.

The semiconductor device includes the first package 10. The details of the first package 10 are the same as described in the first embodiment.

The semiconductor device includes a plurality of second packages 130. Each of the second packages 130 includes a second interposer 132. The details of the second interposer 132 are the same as the above description of the first interposer 12. Furthermore, the second interposer 132 may be made of the same material, to the same thickness, with the same coefficient of thermal expansion as those of the first interposer 12. Alternatively, the second interposer 132 may be made of a different material and to a different thickness from those of the first interposer 12. The coefficient of thermal expansion of one of the first interposer 12 and the second interposer 132 may be larger than that of the other. Note that the coefficient of thermal expansion is the percentage of contraction when cooled down as well as the percentage of expansion when heated. The second wiring pattern 34 is provided to and the second semiconductor chip 36 is mounted on the second interposer 132. The sealing part 44 may also be provided to the second interposer 132. The details thereof are the same as described in the first embodiment.

The plurality of second packages 130 are provided with a gap 134 therebetween so as not to overlap each other. One end of one second package 130 (e.g. second interposer 132 and sealing part 44) is placed face to face with one end of another second package 130 (e.g. second interposer 132 and sealing part 44). The opposing ends may be either flat or curved. While two second packages 130 are arranged in FIG. 15, more than two second packages 130 may be arranged.

The first package 10 and each of the second packages 130 are stacked. Each second interposer 132 and the first interposer 12 are stacked, and each second interposer 132 and the first semiconductor chip 16 are stacked. More specifically, part of the second interposer 132 (edges surrounding the first semiconductor chip 16 including its two corners from three directions in the example shown in FIG. 15, or from either one or two directions as a modification) overlaps part of the first interposer 12 (an area not having the first semiconductor chip 16). Also, part of the second interposer 132 (edges except for corners in the example shown in FIG. 15, or corners as a modification) overlaps part of the semiconductor chip 16 (part unifying its two corers in the example shown in FIG. 15, or part unifying three corners or one corner). The whole of the second interposer 132 is placed to overlap part of the first interposer 12 and part of the first semiconductor chip 16.

The second package 130 (second interposer 132) is stacked on one side of the first package 10 (first interposer 12) on which the first semiconductor chip 16 is mounted. Alternatively, the side of the second package 130 (second interposer 132) on which the second semiconductor chip 36 is mounted may be placed on the other side of the first package 10 (first interposer 12) opposite to the one side on which the first semiconductor chip 16 is mounted.

Provided between the first package 10 (first interposer 12) and the second package 130 (second interposer 132) are the plurality of contact parts 46. The details of each contact parts 46 are the same as described in the first embodiment. Provided between the first interposer 12 and the second interposer 132 is the reinforcing part 50. The reinforcing part 50 is provided in an area not to come in contact with the second interposer 132. The details of the reinforcing part 50 are the same as described in the first embodiment. The semiconductor device includes the plurality of external terminals 52.

The first package 10 and the second package 130 are joined with an adhesive part 136. In the example shown in FIG. 16, the adhesive part 136 joins the first semiconductor chip 16 and the second interposer 132. The adhesive part 136 may be provided to a gap between the first semiconductor chip 16 and the second interposer 132. The adhesive part 136 may be provided inside the first semiconductor chip 16 (e.g. central part of the chip). The adhesive part 136 may be in the gap 134 between adjacent second packages 130. In this case, the adhesive part 136 may contact with (or be joined to) the end of the second interposer 132, or both the ends of the second interposer 132 and the sealing part. 44. Other details of the adhesive part 136 are the same as those described in the first and second embodiments.

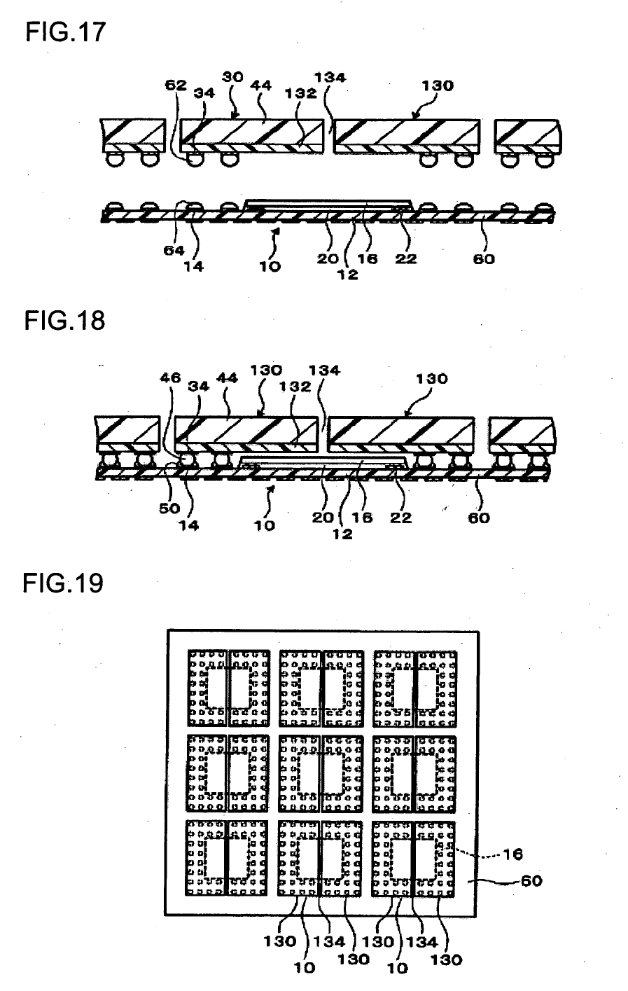

FIGS. 17 to 21 are diagrams showing a method for manufacturing a semiconductor device according to the present embodiment of the invention. The plurality of second packages 130 are provided with the gap 134 therebetween so as not to overlap each other above the first package 10. The second interposer 132 is stacked on one side of the first interposer 12 on which the first semiconductor chip 16 is mounted. Each of the second packages 130 is placed so that the second interposer 132 overlaps part of the first interposer 12 and part of the first semiconductor chip 16. The detailed process may be based on the above description of the first package 10 and the second package 130.

Before stacking the first package 10 (first interposer 12) and the second package 130 (second interposer 132), the first material 62 for forming the contact part 46 and the second material 64 for forming the reinforcing part 50 are provided between the first interposer 12 and the second interposer 132, for example, at least either of the first interposer 12 or the second interposer 132. The first material 62 is provided to the second interposer 132 side, while the second material 64 is provided to the first interposer 12 side. The details of the first and second materials 62, 64 are the same as described in the first embodiment.

The first interposer 60 including areas to be a plurality of first interposers each corresponding to the first interposer 12 may be used, and the plurality of second packages 130 may be stacked in each area to be the first interposer 12. Note that the second package 130 is not stacked on any first package 10 deemed as defective. This way it is possible to prevent the second package 130 (second semiconductor chip 36) from being wasted.

Referring to FIG. 18, heat processing (e.g. reflow processing) is conducted to melt the first and second materials 62, 64, making the contact part 46 from the first material 62 and the reinforcing part 50 from the second material 64. The contact part 46 electrically couples the first package 10 and the second package 130. More specifically, the contact part 46 electrically couples the first wiring pattern 14 and the second wiring pattern 34 between the first interposer 12 and the second interposer 132.

In the present embodiment, as shown in FIG. 19, a plurality of first packages each corresponding to the first package 10 is formed by using the first interposer 60. The plurality of second packages 130 are disposed above each first package 10.

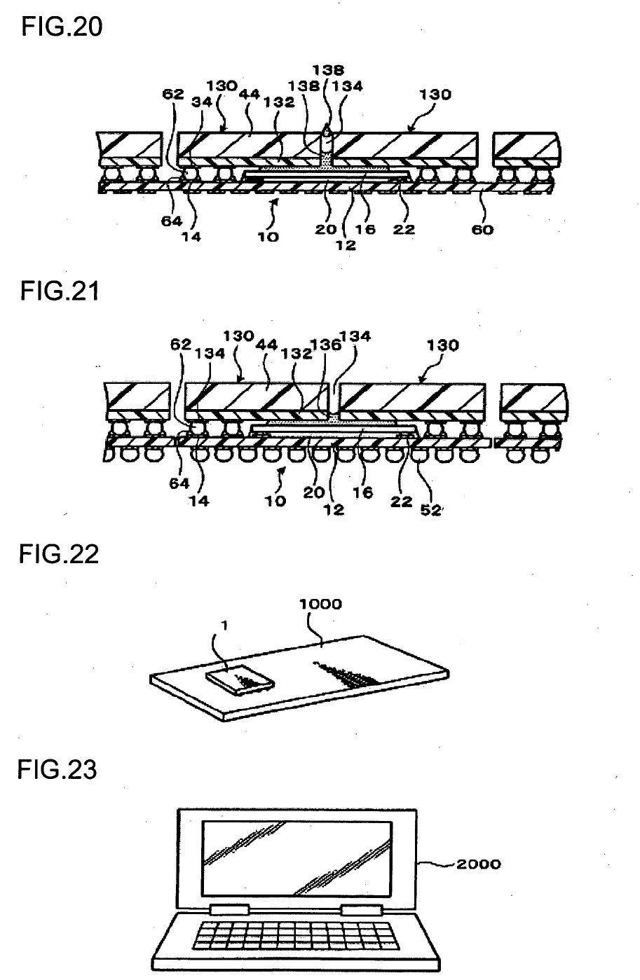

As shown in FIG. 20, an adhesive material 138 is injected between the first package 10 and each second package 130. The adhesive material 138 is injected through the gap 134 between each two of the plurality of second packages 130 (i.e. the gap on the first semiconductor chip 16). This way the adhesive material 138 progresses in the directions of the plurality of second packages 130 from the gap 134. In other words, since the adhesive material 138 progresses in plural directions, the injection is completed in a short period of time.

In the present embodiment, as shown in FIG. 19, the first interposer 60 is used, and the plurality of first packages 10 are arranged. One second package 130 disposed above one first package 10 and another second package 130 disposed above the next first package 10 are placed next to each other. In this case, the two second packages 130 placed next to each other above the two first packages 10 placed next to each other can be close to each other, since a gap between the two second packages is not used for injecting the adhesive material 138.

As shown in FIG. 21, heat processing etc. is conducted to provide the adhesive part 136 between the second interposer 132 and the first semiconductor chip 16. If the above-described first interposer 60 is used, it is cut and divided into a plurality of first interposers each corresponding to the first interposer 12. Also, the external terminal 52 is provided.

As a modification, the adhesive material 138 may be provided to at least either of the first package 10 or the second package 130 before stacking the first package 10 (first interposer 12) and the second package 130 (second interposer 132). The detailed process is the same as described in the first embodiment. The above description of the second embodiment is applicable to the arrangement of the adhesive material 138 here.

The present embodiment provides the semiconductor device through the above-described process. This process includes what is based on the above description about the arrangement of the semiconductor device.

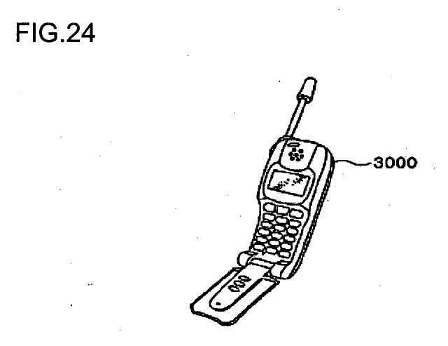

FIG. 22 shows a circuit board 1000 on which a semiconductor device 1 that is manufactured as described in the above embodiments is mounted. FIG. 23 shows a notebook computer 2000 and FIG. 24 shows a cellular phone 3000 as examples of electronic equipment including the semiconductor device.

The present invention is not limited to the above-described embodiments, and various changes and modifications can be made. For example, the invention includes substantially the same structures as those described in the embodiments (e.g., structures involving the same functions, methods, and results, or the same aims and results as those described above). In addition, the invention includes structures obtained by replacing non-essential parts of the structures described in the embodiments. The invention further includes structures that can achieve the same advantageous effects or aims as those described in the embodiments. In addition, the invention includes structures obtained by adding the related art to the structures described in the embodiments.

1. A semiconductor device comprising:
a first package, the first package including:
a first interposer provided with a first wiring pattern, and
a first semiconductor chip mounted on the first interposer and electrically coupled to the first wiring pattern;
a second package, the second package including:
a second interposer provided with a second wiring pattern, and
a second semiconductor chip mounted on the second interposer and electrically coupled to the second wiring pattern;
a contact part electrically coupling the first wiring pattern and the second wiring pattern;
a reinforcing part; and
an adhesive part;
the first package having a larger coefficient of thermal expansion than the second package;
the second package being placed so that the second interposer overlaps the first semiconductor chip and the first interposer;
the contact part having a first end coupled to the first wiring pattern and a second end coupled to the second wiring pattern, and the contact part being provided between the first interposer the second interposer;
the reinforcing part exposing part of the contact part and covering a periphery of the first end of the contact part; and
the adhesive part being provided between the first interposer and the second interposer so as not to come in contact with the contact part, and joining the first package and the second package.

2. The semiconductor device according to claim 1, wherein the adhesive part joins the first semiconductor chip and the second interposer.

3. The semiconductor device according to claim 2, wherein the adhesive part is provided inside the first semiconductor chip.

4. The semiconductor device according to claim 1, wherein the adhesive part joins the first interposer and the second interposer.

5. The semiconductor device according to claim 4, wherein the second interposer has a rectangular outer shape, and the adhesive part is provided to an end of the second interposer.

6. The semiconductor device according to claim 5, wherein the adhesive part is provided to at least one corner of the second interposer.

7. The semiconductor device according to claim 5, wherein the adhesive part is provided to an area except for corners of the second interposer.

8. The semiconductor device according to claim 4, wherein the adhesive part is provided on an inner side of the contact part.

9. The semiconductor device according to claim 1, wherein the second package further includes a sealing part provided to the second interposer so as to seal the second semiconductor chip, and the first interposer has a larger coefficient of thermal expansion than the sealing part.

10. The semiconductor device according to claim 1, further comprising:
a plurality of second packages placed with a gap therebetween so as not to overlap each other.

11. A circuit board comprising the semiconductor device according to claim 1, the semiconductor device being mounted on the circuit board.

12. Electronic equipment comprising the semiconductor device according to claim 1.

13. A method for manufacturing a semiconductor device, comprising:
(a) providing a first package by mounting a first semiconductor chip on a first interposer provided with a first wiring pattern so that the first semiconductor chip is electrically coupled to the first wiring pattern;
(b) providing a second package by mounting a second semiconductor chip on a second interposer provided with a second wiring pattern so that the second semiconductor chip is electrically coupled to the second wiring pattern;
(c) placing the second package so that the second interposer overlaps the first semiconductor chip and the first interposer; and
(d) between the first interposer and the second interposer, making a contact part for electrically coupling the first wiring pattern and the second wiring pattern from a first material, making a reinforcing part from a second material, and making an adhesive part for joining the first package and the second package from an adhesive material;
the first package having a larger coefficient of thermal expansion than the second package;
the contact part including a first end coupled to the first wiring pattern and a second end coupled to the second wiring pattern; and
in the step (d) the reinforcing part is provided to expose part of the contact part and cover a periphery of the first end of the contact part, and the adhesive part is provided to join the first package and the second package and not to come in contact with the contact part.

14. The method for manufacturing a semiconductor device according to claim 13, wherein the adhesive material is provided to at least one of the first package and the second package before the step (c).

15. The method for manufacturing a semiconductor device according to claim 13, wherein
a plurality of second packages are provided in the step (b), and
the plurality of second packages are placed with a gap therebetween so as not to overlap each other in the step (c).

16. The method for manufacturing a semiconductor device according to claim 15, wherein the adhesive material is injected from the gap between the plurality of second packages before the step (d).
